(19) United States
(12) Patent Application Publication
(10) Pub. No.: US 2026/0003148 A1
(43) Pub. Date: Jan. 1, 2026

(54) HELIX PASS-THROUGH FURCATION BODY AND ASSOCIATED METHODS

(71) Applicant: CORNING RESEARCH & DEVELOPMENT CORPORATION, Corning, NY (US)

(72) Inventors: Brandon Duvall Compton, Newton, NC (US); Cameron Blake Crisp, Newton, NC (US); Brandon O’Brien Norwood, Lincolnton, NC (US)

(21) Appl. No.: 19/244,441

(22) Filed: Jun. 20, 2025

Related U.S. Application Data
(60) Provisional application No. 63/665,333, filed on Jun. 28, 2024.

(51) Int. Cl. G02B 6/44; G02B 6/54

(52) U.S. Cl. CPC G02B 6/4434; G02B 6/44715; G02B 6/545

(57) ABSTRACT

A fiber optic cable assembly is provided. The fiber optic cable assembly includes a fiber optic cable with an outer jacket that surrounds a plurality of subunits each containing at least one optical fiber. The outer jacket includes an end through which the plurality of subunits extends. The fiber optic cable assembly includes a furcation assembly proximate the end of the outer jacket through which the plurality of subunits extends. The furcation assembly includes a furcation plug that extends longitudinally a length between a first end and an opposite second end, The furcation plug includes a plurality of grooves that extend helically about a periphery of the furcation plug between the first end and the second end. Each of the plurality of grooves receives a respective one of the plurality of subunits such that each of the plurality of subunits is wrapped around the furcation plug at least one time.

### PRIORITY APPLICATION

This application claims the benefit of priority of U.S. Provisional Application No. 63/665,333, filed on Jun. 28, 2024, the content of which is relied upon and incorporated herein by reference in its entirety.

### TECHNICAL FIELD

This disclosure relates generally to fiber optic cables, and more particularly to fiber optic cable furcation assemblies and methods.

### BACKGROUND

The large amount of data and other information transmitted over the internet has led businesses and other organizations to develop large scale data centers for organizing, processing, storing, and/or disseminating large amounts of data. Data centers contain a wide range of information technology (IT) equipment including, for example, servers, networking switches, routers, storage subsystems, etc. Data centers further include a large amount of cabling and racks to organize and interconnect the IT equipment in the data center. Modern data centers may include multi-building campuses having, for example, one primary or main building and a number of auxiliary buildings in close proximity to the main building. All the buildings on the campus are interconnected by a local fiber optic network. Cables may be routed through conduits, ducts, raceways, etc. (“pathways”) within and between the buildings.

To route the fiber optic cables through these pathways during installation or upgrades, for example, one end of the cable is typically equipped with a pull grip assembly (referred to as a “pull grip” or “pulling grip”). A tension member, which extends through the pathway, is then coupled to the pulling grip, allowing the fiber optic cable to be pulled through the pathway. Depending on factors such as the size of the fiber optic cable, the length of the pathway, and the resistance encountered during pulling, the cable and its subunits may be subjected to high tensile forces, potentially reaching several hundreds of pounds.

A furcation point is a critical aspect of fiber optic cable design, particularly in the context of the high tensile forces experienced during cable installation. The furcation point is where the fiber optic cable may split into individual fibers, smaller bundles of fibers, or where input cables are coupled to output cables. One function of the furcation point is to distribute tensile forces evenly across the subunits of the fiber optic cable to prevent damage and ensure the integrity of signal transmission after the pulling operation.

Conventional furcation designs, especially where input cables are coupled to output cables, typically feature an epoxy plug at the furcation point. The internal strength elements of each cable (both input and output) are accessed and encapsulated within the adhesive of the epoxy plug. This bonding of strength elements allows tensile loads to transfer along the strength elements from one cable to the other, minimizing tensile loads on the more delicate subunits and fibers within the cables.

In some cases, one or more cables may need to pass through the furcation point, a configuration known as pass-through furcation. In a pass-through furcation, the input cable passes through the furcation point and continues out as the output cable. In this configuration, the tensile loads may be limited to the external member of each subunit (i.e., the subunit cable jacket), which lacks the strength to withstand significant loads from pulling. For a pass-through furcation, accessing the internal strength elements of each subunit is more difficult and may risk damaging the optical fibers within. An epoxy plug or heat shrink could be applied as described in the previous furcation design, but the adhesive layer would only contact the outer cable jacket of each subunit. This limitation, where tensile loads are only transitioned through the cable jacket, creates issues because the strength elements (e.g., aramid yarn) of each subunit are free-floating inside the jacket. As a result, all tensile loads applied to the external jacket of each subunit remain within the jacket and cannot be transferred to the strength elements, which run parallel to the cable.

Accordingly, there is a need for a pass-through fiber optic cable furcation assembly capable of withstanding the significant loads encountered during cable pulling operations without the need to expose and couple the internal strength elements of each cable subunit passing through the furcation point.

### SUMMARY

In one aspect of the disclosure, a fiber optic cable assembly is provided. The fiber optic cable assembly includes a fiber optic cable with an outer jacket that surrounds a plurality of subunits each containing at least one optical fiber. The outer jacket includes an end through which the plurality of subunits extends. The fiber optic cable assembly includes a furcation assembly proximate the end of the outer jacket through which the plurality of subunits extends. The furcation assembly includes a furcation plug that extends longitudinally a length between a first end and an opposite second end. The furcation plug includes a plurality of grooves that extend helically about a periphery of the furcation plug between the first end and the second end. Each of the plurality of grooves receives a respective one of the plurality of subunits such that each of the plurality of subunits is wrapped around the furcation plug at least one time.

In one embodiment, each of the plurality of subunits may be wrapped around the furcation plug a same number of times. Further, each of the plurality of subunits may be wrapped around the furcation plug at least three times.

In another embodiment, the furcation plug may include a first end region adjacent the first end, a second end region adjacent the second end, and a middle region between the first end region and the second end region. For each of the plurality of grooves, a pitch of the groove in the middle region may be different from a pitch of the groove in the first end region and the second end region. For example, for each of the plurality of grooves, the pitch of the groove at the first end region and the second end region may be greater than the pitch of the groove in the middle region. In one embodiment, for each of the plurality of grooves, the pitch of the groove may gradually decrease along a length of the first end region in a direction from the first end toward the middle region and may gradually increase along a length of the second end region in a direction from the middle region toward the second end of the furcation plug.

In yet another embodiment, each of the plurality of grooves may be recessed from an outer surface of the furcation plug such that 50% or more of a diameter of each of the plurality of subunits is positioned within the respective groove and below the outer surface of the furcation plug.

In one embodiment, each groove may include an opening to the groove at the first end and the second end of the furcation plug. In another embodiment, the furcation plug may include a projection at each of the first end and the second end. Further, the openings to the plurality of grooves may be arranged circumferentially about each projection. Each projection may be conical in shape, and a tip of each projection may be spaced axially away from the opening to each of the plurality of grooves.

In another embodiment, each of the plurality of subunits may enter or exit its respective groove at the first end and the second end of the furcation plug. Further, an axis of each of the plurality of subunits may be aligned within 10° of parallel to a longitudinal axis of the furcation plug at each of the first end and the second end of the furcation plug. Each of the plurality of grooves may include a base wall that is curved in transverse cross-sectional shape.

In one embodiment, each of the plurality of subunits may be terminated with at least one fiber optic connector. Additionally, or alternatively, the furcation assembly may include a sleeve disposed over the furcation plug. In another embodiment, the furcation assembly further include a first maintaining member applied to the sleeve over the furcation plug at the first end and a second maintaining member applied to the sleeve over the furcation plug at the second end.

In another aspect of the disclosure, a method of making a fiber optic cable assembly is provided. The method includes providing a fiber optic cable with an outer jacket that surrounds a plurality of subunits each containing at least one optical fiber and at least one fiber optic connector on an end. The outer jacket includes an end through which the plurality of subunits extends. The method further includes providing a furcation assembly proximate the end of the outer jacket through which the plurality of subunits extends. The furcation assembly includes a furcation plug that extends longitudinally a length between a first end and an opposite second end. The method includes wrapping each of the subunits around the furcation plug such that each of the subunits is positioned in a respective one of a plurality of grooves that extend helically about a periphery of the furcation plug to define a furcation point of the fiber optic cable.

In one embodiment, the method may include providing a first maintaining member and a second maintaining member as part of the furcation assembly. The method may further include mating the first maintaining member to the first end of the furcation plug and mating the second maintaining member to the second end of the furcation plug. The furcation plug may be held captive between the first maintaining member and the second maintaining member. In another embodiment, the method may include providing a sleeve as part of the furcation assembly and wrapping the sleeve around the furcation plug.

In another aspect of the disclosure, a furcation plug for a furcation assembly of a fiber optic cable with a plurality of subunits is provided. The furcation plug includes a body that extends longitudinally a length between a first end and an opposite second end and a plurality of grooves that extend helically about a periphery of the furcation plug between the first end and the second end. Each of the plurality of grooves is configured to receive a respective one of the plurality of subunits such that each of the plurality of subunits is wrapped around the furcation plug at least one time.

In one embodiment, the body of the furcation plug may include a first end region adjacent the first end, a second end region adjacent the second end, and a middle region between the first end region and the second end region. For each of the plurality of grooves, a pitch of the groove in the middle region may be different from a pitch of the groove in the first end region and the second end region. Further, for each of the plurality of grooves, the pitch of the groove at the first end region and the second end region may be greater than the pitch of the groove in the middle region. In another embodiment, for each of the plurality of grooves, the pitch of the groove may gradually decrease along a length of the first end region in a direction from the first end toward the middle region and may gradually increase along a length of the second end region in a direction from the middle region toward the second end of the furcation plug.

In yet another embodiment, each groove may include an opening to the groove at the first end and the second end of the furcation plug. For example, an axis of each of the plurality of grooves may be aligned within 10° of parallel to a longitudinal axis of the furcation plug at each opening to the plurality of grooves at each of the first end and the second end of the furcation plug. Additionally, the furcation plug may include a projection at each of the first end and the second end. The openings to the plurality of grooves may be arranged circumferentially about each projection. In one embodiment, each projection may be conical in shape, and a tip of each projection may be spaced axially away from the opening to each of the plurality of grooves. In one embodiment, each groove may include a base wall that is curved in transverse cross-sectional shape.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic illustration of a data center campus according to an embodiment of the disclosure.

FIG. 2 is a partial perspective view of an embodiment of a data hall of the data center of FIG. 1.

FIG. 3 is a schematic view of an embodiment of a row of equipment racks of the data hall of FIG. 2

FIG. 4 is a cross-sectional view of a fiber optic cable including a strength member according to an embodiment of the disclosure.

FIG. 5 is a perspective view of a fiber optic cable assembly including the fiber optic cable of FIG. 4, illustrating a furcation assembly of the fiber optic cable assembly.

FIG. 6 is a perspective view of a furcation plug of the furcation assembly of FIG. 5 according to an embodiment of the disclosure.

FIG. 7 is a perspective view of the furcation plug of FIG. 6 wrapped with one or more of the subunits of the fiber optic cable.

FIG. 8 is a perspective view of the furcation plug of FIG. 7, illustrating the furcation plug covered by a sleeve.

FIG. 9 is a view similar to FIG. 8, illustrating a pair of maintaining members applied to the sleeve to hold the furcation plug captive.

FIG. 10 is a perspective view of a furcation plug of the furcation assembly of FIG. 5 including a pulling eye according to another embodiment of the disclosure.

### DETAILED DESCRIPTION

Various embodiments will be further clarified by examples in the description below. In general, the description relates to a furcation plug, otherwise referred to as a furcation body, for a pass-through fiber optic cable furcation assembly. The furcation plug forms part of the furcation assembly and defines a furcation point or region along a fiber optic cable. In particular, one or more pass-through cable subunits of the fiber optic cable are configured to be wrapped about the furcation body as they pass through the furcation assembly. The pass-through cable subunits are each wrapped in a prescribed helical path about the furcation plug to thereby couple the subunits to the furcation plug. That is, the helical wrapping of each subunit about the furcation plug has the net effect of coupling the internal cable components of each subunit together allowing for loads, such as tensile loads that may be experienced during a pulling operation, to be transferred through the strength member of each subunit rather than the external cable jacket of the subunit. Absent the furcation plug, the tensile loads in a pass-through furcation may be borne by the cable jacket of each subunit which lacks the strength to withstand significant tensile forces. As described above, with a pass-through furcation design, it is problematic to expose the strength element of each subunit (e.g., aramid yarn). Therefore, an indirect method of coupling tensile loads to the strength element of each subunit is generated by wrapping the cable subunits along a helical path about the furcation plug. These and other benefits of the disclosure will be described more fully below.

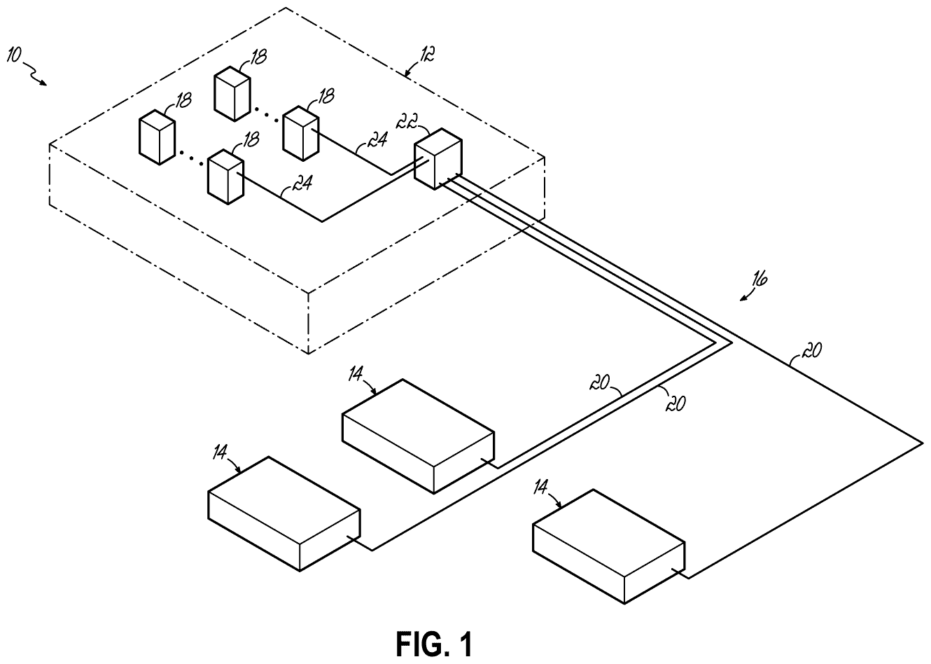

As illustrated in FIG. 1, a modern-day data center 10 may include a collection of buildings (referred to as a data center campus) having, for example, a main building 12 and one or more auxiliary buildings 14 in close proximity to the main building 12. While three auxiliary buildings 14 are shown, there may be more or less depending on the size of the campus. The data center 10 provides for a local fiber optic network 16 that interconnects the auxiliary buildings 14 with the main building 12. The local fiber optic network 16 allows network equipment 18 in the main building 12 to communicate with various network equipment (not shown) in the auxiliary buildings 14. In the exemplary embodiment shown, the local fiber optic network 16 includes trunk cables 20 extending between the main building 12 and each of the auxiliary buildings 14. Conventional trunk cables 20 generally include a high fiber-count arrangement of optical fibers for passing data and other information through the local fiber optic network 16. In the example illustrated in FIG. 1, the trunk cables 20 from the auxiliary buildings 14 are routed to one or more distribution cabinets 22 housed in the main building 12 (one shown).

Within the main building 12, a plurality of indoor fiber optic cables 24 are routed between the network equipment 18 and the one or more distribution cabinets 22. The indoor cables 24 generally include a high fiber-count arrangement of optical fibers for passing data and other information from the distribution cabinets 22 to the network equipment 18. Although only the interior of the main building 12 is schematically shown in FIG. 1 and discussed above, each of the auxiliary buildings 14 may house similar equipment for similar purposes. Thus, although not shown, each of the trunk cables 20 may be routed to one or more distribution cabinets 22 in one of the auxiliary buildings 14 in a manner similar to that described above. Furthermore, each of the auxiliary buildings 14 may include indoor cables 24 that extend between network equipment 18 and the one or more distribution cabinets 22 of the auxiliary building 14.

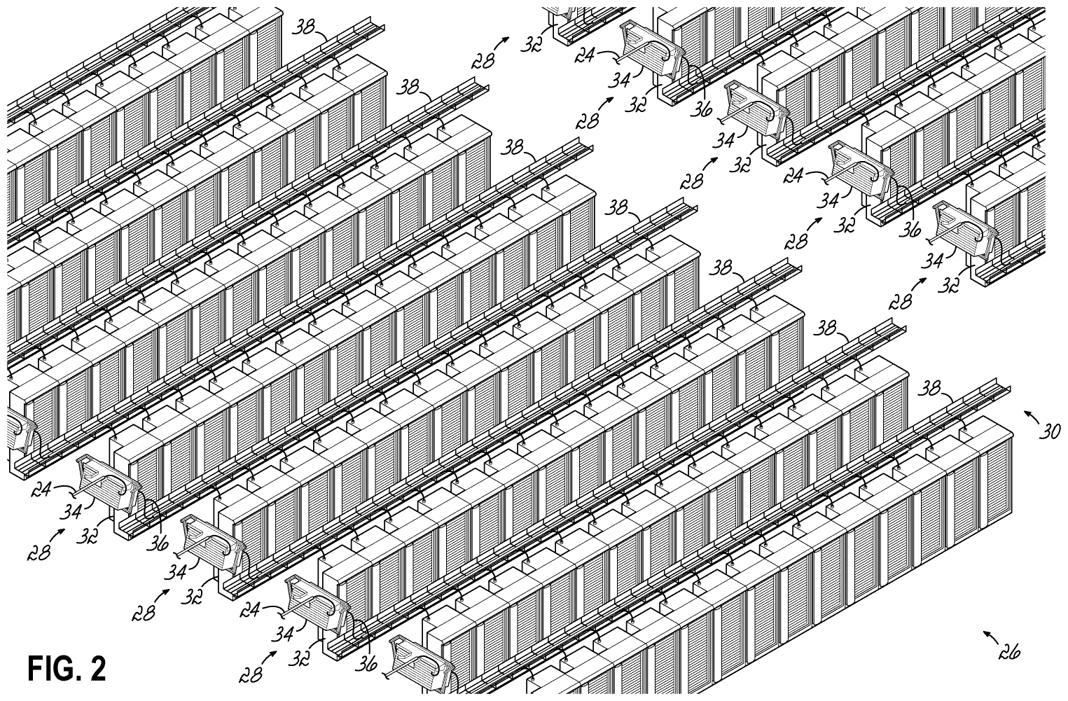

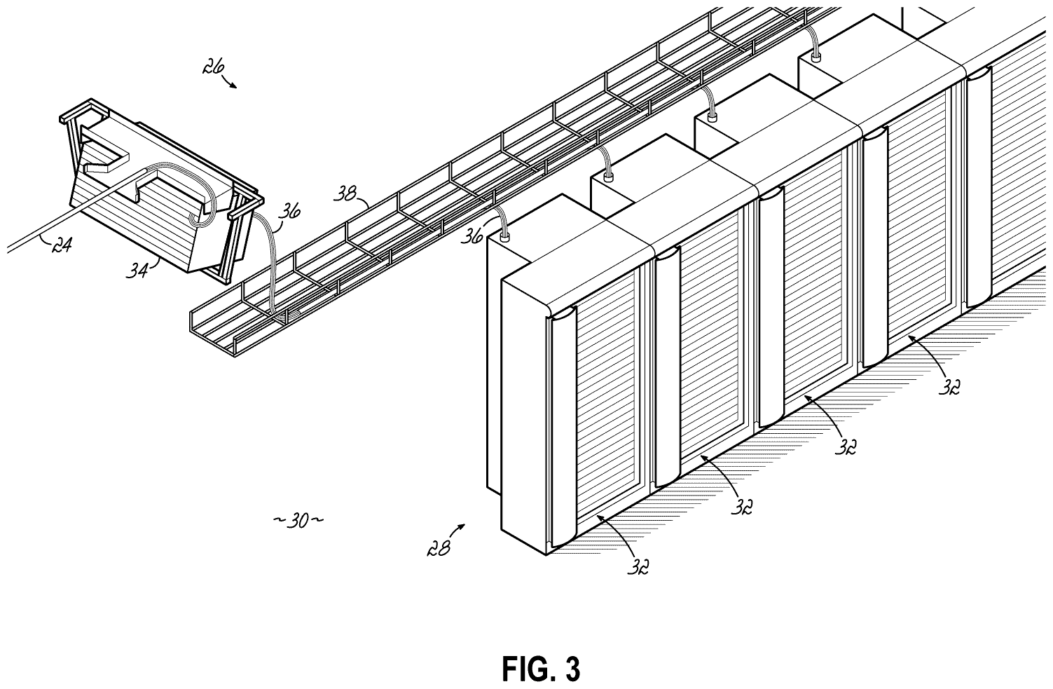

As illustrated in more detail in FIGS. 2 and 3, the network equipment 18 in the main building 12 or an auxiliary building 14 may be arranged in one or more data halls 26 that generally include a plurality of spaced-apart rows 28 on one or both sides of an access pathway 30. The arrangement of the data halls 26 into rows 28 helps organize the large number of equipment, fiber optic cables, fiber optic connections, etc. Each of the rows 28 includes a plurality of equipment racks (or cabinets) 32 generally arranged one next to the other along the row 28. Each of the equipment racks 32 is a vertically arranged framework for holding various network equipment 18 of the data center 10, as is generally known in the telecommunications industry. In one common arrangement, and as further illustrated in FIG. 2, each row 28 may include an intermediate distribution frame 34 at the head end of the row 28 closest to the access pathway 30.

The intermediate distribution frame 34 represents a termination point of at least some of the optical fibers carried by one or more of the indoor cables 24, for example. Although the intermediate distribution frame 34 is shown as being positioned above the row 28, in other embodiments the intermediate distribution frame 34 may be in a cabinet (not shown) at the head end of the row 28 or in the first equipment rack 32 at the head end of the row 28. In yet other embodiments, the intermediate distribution frame 34 may be located within the associated row 28, such as in the middle of the row 28, and be above, below, or within one of the equipment racks 32. In a conventional arrangement, one or more distribution cables 36 are connected to the intermediate distribution frame 34 of a row 28 and routed along a cable tray 38 generally disposed above the row 28. The network equipment 18 in the equipment racks 32 is then optically connected to the one or more distribution cables 36 to provide the interconnectivity of the network equipment 18 (e.g., equipment racks 32) of the data center 10.

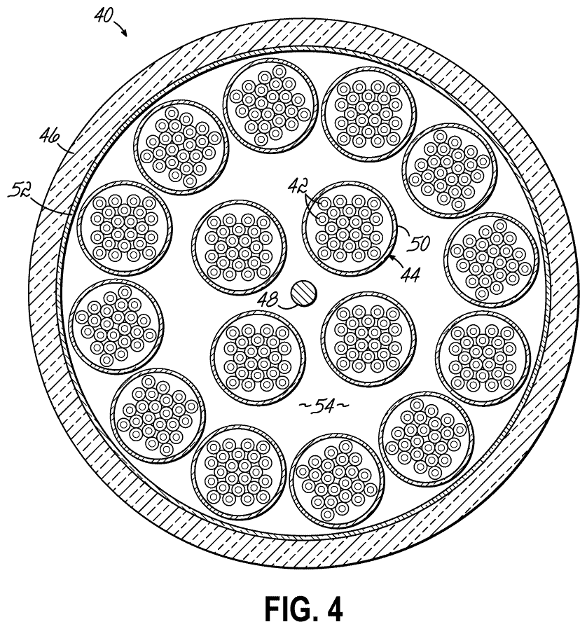

Referring now to FIG. 4, a fiber optic cable 40 generally includes a high fiber-count arrangement of optical fibers 42 for passing data and other information through the local fiber optic network 16. The fiber optic cable 40 may be a row distribution cable 36, described above. Further, aspects of the disclosure may also prove beneficial to an indoor cable 24 or a trunk cable 20, also described above. Regardless, the number of optical fibers 42 carried by the fiber optic cable 40, how the optical fibers 42 are arranged within the fiber optic cable 40, and how the fiber optic cable 40 is constructed may vary based on the application. The fiber optic cable 40 in the depicted embodiment includes a plurality of routable subunits 44, otherwise referred to as cable legs, and each routable subunit 44 is configured to carry a pre-selected number of optical fibers 42. Although the fiber optic cable 40 is shown as including sixteen routable subunits 44, the number of subunits 44 may be more or less than this number in alternative embodiments. The routable subunits 44 may be arranged within an outer protective sheath or outer jacket 46, as is generally known in the industry.

The fiber optic cable 40 generally includes at least one strength member 48 that extends along a length of the fiber optic cable 40 and provides tensile strength to the fiber optic cable 40 during installation of the fiber optic cable 40 in a pathway (e.g., an indoor/outdoor conduit or duct, a cable tray 38, etc.) of the fiber optic network. In the example embodiment shown, the strength member 48 is located within the fiber optic cable 40 among the subunits 44. However, it is to be understood that one or more strength members 48 could be located in alternative locations in the fiber optic cable 40 (e.g., in the outer jacket 46). Each of the routable subunits 44 is configured to carry a pre-selected number of optical fibers 42. By way of example and without limitation, each routable subunit 44 may be configured to carry 24 optical fibers 42. It should be recognized, however, that more or less optical fibers 42 may be carried by each of the routable subunits 44. In one embodiment, the optical fibers 42 may be loosely held within an outer subunit sheath or jacket 50 of each subunit 44.

With continuing reference to FIG. 4, a strain-relief element 52 may be disposed in an interior 54 of the cable adjacent jacket 46 and surrounding the subunits 44. Strain-relief element 52 may include, for example, a layer of yarn or yarns (e.g. aramid yarn) for absorbing tensile loads. The strain-relief element 52 is shown with a uniform thickness, however, the strain relief element 52 may have a non-uniform thickness because the locations of the subunits 44 or other internals of the cable 40 may cause the strain-relief element 52 to compress at various locations along the length of the cable 40.

Those skilled in optical communications will appreciate that the fiber optic cable 40 is merely an example to facilitate discussion, and that other types of constructions are possible for the fiber optic cable 40. In alternative embodiments, for example, the subunits 44 may be individual, discrete cables (e.g., “jumpers”) surrounded by an outer covering that serves as the outer jacket 46 and effectively bundles the subunits together 44. The outer covering may be an extruded polymer material like a conventional cable jacket, a mesh material in which the subunits 44 are placed, or even plastic wrap or the like applied around a group of subunits 44 to bundle them together. As such, the term “outer jacket” is used in this disclosure in a broad sense, referring generally to material surrounding subunits 44 so that the subunits are effectively contained for a certain length and can be handled together as a cable. It will also be appreciated that there may not be any strength member(s) 48 and/or strain-relief element 52 in alternative embodiments.

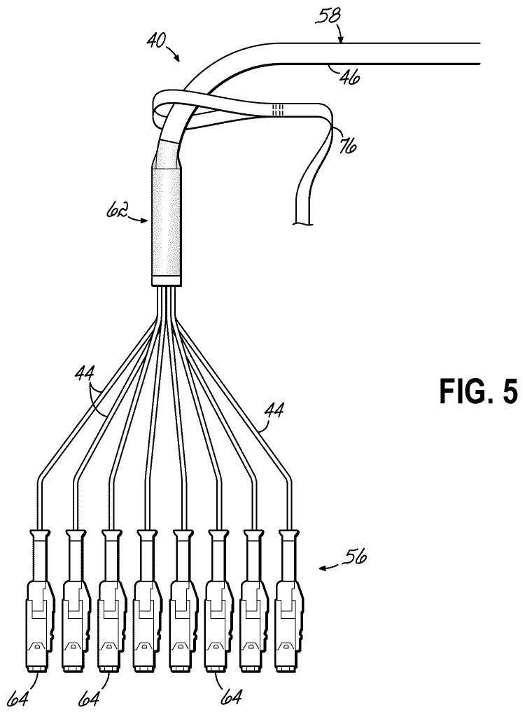

Referring now to FIG. 5, the fiber optic cable 40 has a distribution end 56, a main cable section 58, and a terminal end (not shown) opposite the distribution end 56, which may together form a fiber optic cable assembly. Only a portion of the main cable section 58 is shown in FIG. 5, and in some embodiments the terminal end may have a configuration similar to the distribution end 56 such that discussion of the distribution end 56 may equally apply to the terminal end in such embodiments. However, embodiments are also possible where the terminal end has a configuration different than the distribution end 56.

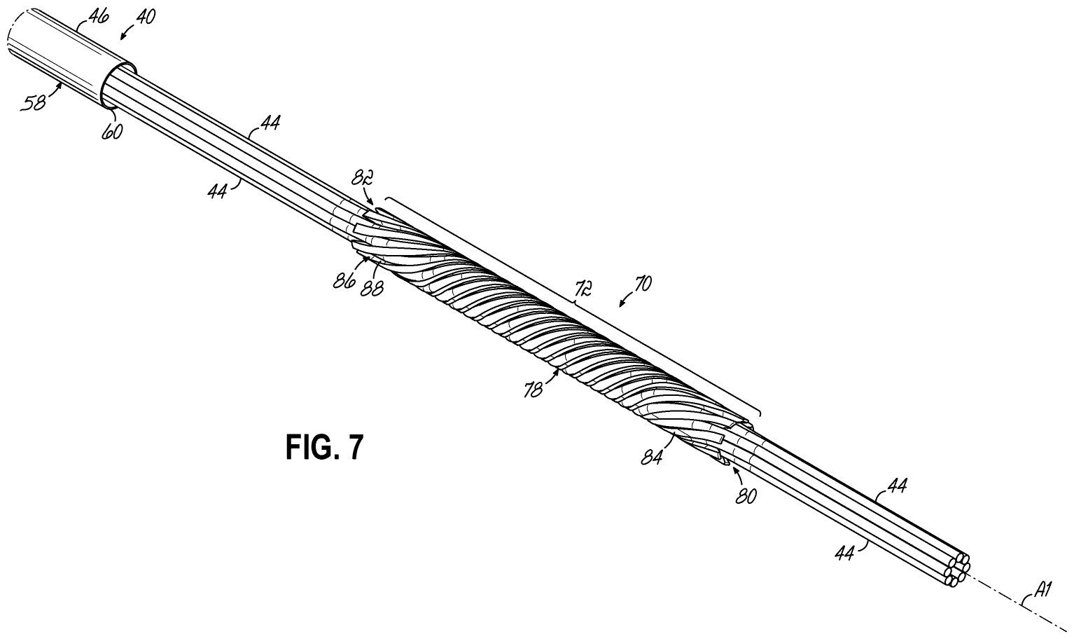

With continued reference to FIG. 5, to prepare the fiber optic cable 40 for installation through a pathway, the outer jacket 46 may be removed or stripped to expose a working length of the optical fibers 42 and routable subunits 44, forming a jacket end 60 of the fiber optic cable 40 (e.g., FIG. 7). Proximate the jacket end 60 of the fiber optic cable is a furcation assembly 62 through which the routable subunits 44 pass through and extend to a respective end. In that regard, the end of each subunit 44 may include a fiber optic connector 64 on the end, such as at least one multifiber connector. The fiber optic cable 40 may be considered a pre-connectorized cable with connectorized subunits 44. Eight subunits 44 are shown in FIG. 5 by way of illustration. However, the fiber optic cable 40 may include fewer or more routable subunits 44 as needed.

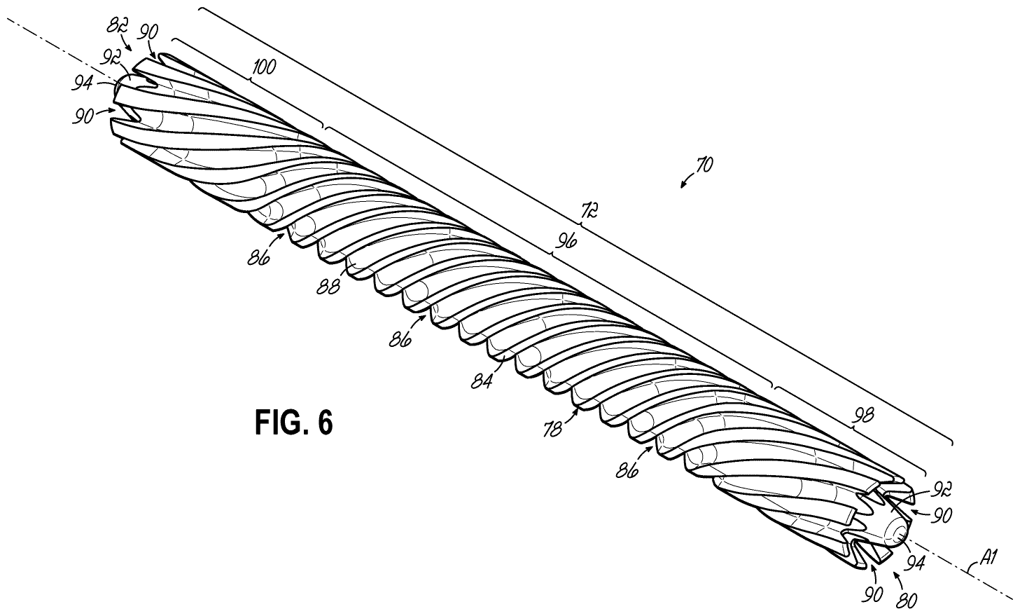

The furcation assembly 62 may be proximate or connected to the jacket end 60 of the fiber optic cable 40. The furcation assembly 62 includes a furcation plug 70 (e.g., FIGS. 6 and 7) around which the subunits 44 of the fiber optic cable 40 are helically wrapped to establish a furcation point 72 of the fiber optic cable 40. The subunits 44 pass through the furcation point 72 without having their outer jackets 50 removed or stripped to expose internal strength elements or other components of the subunit 44. However, the furcation point 72 is a region of the fiber optic cable 40 where tensile forces borne by the fiber optic cable 40, particularly the routable subunits 44, are evenly distributed across these subunits 44 and in particular a strength element of each subunit. These tensile forces may result from pulling the fiber optic cable 40 through a pathway using a pulling grip, for example. Regardless, the furcation point 72 serves to prevent damage to the fibers and ensures the integrity of signal transmission after the pulling operation. By helically wrapping the subunits 44 around the furcation plug 70, the internal components of each subunit 44 are accessed, allowing loads, such as those experienced during a cable pulling operation, to be transferred through the internal strength member of each subunit 44 rather than the external cable sheath 50, as will be described in further detail below.

The furcation assembly 62 may optionally include a furcation housing disposed over the furcation plug 70, which in some embodiment may be a heat shrink tube applied over the furcation plug 70. The furcation housing adds protection to the routable subunits 44 wrapped about the furcation plug 70 and may also serve to further secure the subunits 44 in their wrapped configuration. As shown in FIG. 5, the furcation assembly 62 may have an outer diameter that is larger compared to an outer diameter of the main cable section 58, creating a furcation bulge. The furcation bulge may facilitate handling of the fiber optic cable assembly by providing a gripping/handling location for use by field personnel or an engagement point for a pulling member 76. To that end, the pulling member 76 may be cinched down behind the furcation assembly 62 which acts as a stopper. When loaded, the pulling member 76 pulls against the furcation assembly 62 to pull the fiber optic cable 40.

Turning now with reference to FIG. 6, the furcation plug 70 of the furcation assembly 62 is shown according to one embodiment of the disclosure. The furcation plug 70 includes a cylindrical body 78 that extends longitudinally a length between a first end 80 and an opposite second end 82. The body 78 of the furcation plug 70 defines a longitudinal axis A1 of the furcation plug 70. Further, the body 78 is rigid, exhibiting little to no axial flex or radial compressibility. The body 78 of the furcation plug 70 includes an outer surface 84 that extends between the two ends 80, 82 to define a periphery and outer diameter of the furcation plug 70. The outer diameter of the exemplary furcation plug 70 is 11 mm, but may be within a range of between 5 mm to 30 mm, for example. Formed in the body 78 of the furcation plug 70, and in particular the outer surface 84, is a plurality of grooves 86 that extend helically about the periphery of the body 78 of the furcation plug 70 between the first end 80 and the second end 82. The grooves 86 are evenly spaced apart circumferentially about the body 78 of the furcation plug 70. Each groove 86 includes a base wall 88 having a curved transverse cross-sectional shape (i.e., a cross-section taken along a plane perpendicular to the longitudinal axis A1), sized to closely accommodate the outer diameter of a subunit 44. To that end, each groove 86 is configured to receive one subunit 44 of the fiber optic cable 40, as will be described in further detail below.

With continued reference to FIG. 6, each groove 86 includes an opening 90 to the groove 86 at the first end 80 and at the second end 82 of the body 78 of the furcation plug 70. In particular, the opening 90 to each groove 86 at each end 80, 82 of the body 78 of the furcation plug 70 is arranged circumferentially about a projection 92 at each end 80, 82 of the body 78 of the furcation plug 70. As shown, each projection 92 is generally conical in shape, tapering in a direction away from the openings 90 and along the longitudinal axis A1 to a tip 94 that defines a vertex of the cone shaped projection 92. That is, the tip 94 of each projection 92 is spaced axially away from the opening 90 to each groove 86. The projections 92 may be referred to as an entry or exit cone, and each provides axial support for the subunits 44 at a respective end 80, 82 of the furcation plug 70. The base wall 88 at the openings 90 to the grooves 86 at each end 80, 82 of the furcation plug 70 may be notched to permit lateral movement of each subunit 44 received by the furcation plug 70, thereby preventing restriction that could damage the fibers 42.

The geometry of the helical path of the grooves 86 about the body 78 of the furcation plug 70 is largely driven by the tensile load requirements that the fiber optic cable 40 is expected to experience for a particular application. That is, the helical path of the grooves 86 must provide sufficient contact between the subunits 44 and the furcation plug 70 to immobilize and couple the internal cable components of each subunit 44 together allowing for loads, such as tensile loads that may be experienced during a pulling operation, to be transferred through the strength member of each subunit 44 rather than the external cable sheath 50 of the subunit 44. In that regard, each groove 86 includes a pitch, being the linear distance along the axis A1 of the furcation plug 70 between successive turns of the groove 86 about the furcation plug 70. Groove pitch indicates how tightly or loosely the subunit 44 or fiber 42 is wrapped around the furcation plug 70. However, the helical path of the grooves 86 (i.e., pitch) must not violate the minimum bend radius of the optical fibers 42. In that regard, bend radius, otherwise referred to as wrap angle (0), is the angle that a subunit 44 or fiber 42 makes with a fixed point on the circumference of the body 78 of the furcation plug 70 as it wraps therearound. The wrap angle and pitch are directly related through the geometry of the helical grooves 86. For example, decreasing the pitch, or reducing the distance between consecutive turns of a groove 86, effectively increases the wrap angle for a given subunit 44, and vice versa. This tighter wrapping enhances mechanical stability and friction against tensile loading. By wrapping the subunits 44 around the furcation plug 70, the friction between the internal elements of each subunit 44 increases exponentially per quantity of turns along the furcation plug 70.

The Capstan Equation set forth below describes how wrapping a subunit about the furcation plug 70 (i.e., a capstan) allows a small tensile force to hold a much larger load. That is, the Capstan Equation may be used to determine the geometry of the helical grooves 86 to ensure that tensile loads experienced by the fiber optic cable 40 during a pulling operation are effectively transferred through the strength member of each subunit 44 rather than the external cable sheath 50.

$${T}_{1} = {T}_{0} * {e}^{μθ}$$

In the Capstan Equation above, T₁ is the tension in the fiber optic cable 40 on the load side of the furcation plug 70 and furcation point 72 (e.g., the main cable section 58). T₀ is the tension in the subunit 44 on the input side, being the connectorized end that may be secured in a pulling grip for pulling the fiber optic cable 40, for example. μ is the coefficient of friction between the subunit 44 and the furcation plug 70. θ is the angle of contact (wrap angle) between the subunit 44 and the furcation plug 70 in radians.

The Capstan Equation may be applied to tailor the design the furcation plug 70 to each application, and in particular the groove 86 geometry, in several ways. For instance, the amount of friction required to keep the subunits 44 in place without slipping axially may be calculated using the Capstan Equation. This equation may also be used to determine the tension each subunit 44 experiences when wrapped around the furcation plug 70. By adjusting the wrap angle θ, the security or coupling force between the subunits 44 and the furcation plug 70 may be controlled; a larger wrap angle increases the frictional force, thereby holding the subunits 44 more securely. Additionally, the coefficient of friction μ may be used to guide material selection for the furcation plug 70 to optimize performance. For example, the base wall 88 of each groove 86 may include friction-increasing features, such as a coating or an abrasive surface(s), where appropriate.

In the exemplary embodiment of the furcation plug 70 shown in FIG. 6, the pitch of each groove 86, and thus the resultant wrap angle of the subunit 44, is variable. That is, the pitch of each groove 86 varies along the length of the furcation plug 70 between ends 80, 82. Specifically, the wrap angle of each groove 86 is most aggressive (i.e., at a maximum or greatest) in a middle region 96 of the furcation plug 70. The pitch may be approximately 30 mm and the bend radius may be approximately 20 mm in the middle region 96, for example. Toward the ends 80, 82 of the furcation plug 70, in respective end regions 98, 100, the pitch of each groove 86 gradually increases resulting in a less aggressive wrap angle compared to the middle region 96. The pitch of each groove 86 at the end regions 98, 100 of the furcation plug 70 may be greater compared to the pitch of the grooves 86 in the middle region 96. As shown, the pitch of each groove 86 gradually decreases along a length of the first end region 98 in a direction from the first end 80 of the furcation plug 70 in a direction toward the middle region 96 and gradually increases along a length of the second end region 100 in a direction from the middle region 96 toward the second end 82 of the furcation plug 70. The advantage of this variable pitch configuration for each groove 86 is that each subunit 44 experiences less of a sharp corner or turn as it enters and exists the openings 90 of the groove 86 at the ends 80, 82 of the furcation plug 70, minimizing optical losses due to macro/micro bending of the subunit 44. In an alternative embodiment, the grooves 86 may each include a fixed pitch along the length of the furcation plug 70, for example. In another embodiment, the pitch of the grooves 86 may only be varied at one end of the furcation plug 70.

Turning now with reference to FIG. 7, the furcation plug 70 establishes the furcation point 72 of the fiber optic cable 40 where a length of each subunit 44 is wrapped in a coiling or helical fashion about the furcation plug 70. The furcation plug 70 and thus the furcation point 72 are proximate the jacket end 60 of the fiber optic cable 40, as shown. Each subunit 44 is configured to be received within a respective groove 86 of the furcation plug 70. As shown, each groove 86 is recessed from the outer surface 84 of the furcation plug 70 such that 50% or more, and in particular 90% or more of a diameter of each subunit 44 is received within the groove 86 and below the outer surface 84 of the furcation plug 70. As a result, a diameter of the fiber optic cable 40 at the furcation point 72 is slightly larger compared to a diameter of the bundle of subunits 44. The diameter of the fiber optic cable 40 at the furcation point 72 may be the same or slightly larger compared to the diameter of the main cable section 58 of the fiber optic cable 40.

With continued reference to FIG. 7, each subunit 44 is wrapped a same number of times around the furcation plug 70 as a result of the identical pitch of the grooves 86. Each subunit 44 may be wrapped at least three times, and in the embodiment shown six times around the furcation plug 70. However, this may vary depending on the application, and each subunit 44 may be wrapped fewer or more times around the furcation plug 70. Each subunit 44 is configured to enter or exit a respective groove 86 of the furcation plug 70 at each opening 90 at the first end 80 and the second end 82 of the furcation plug 70 such that an axis of each subunit 44 is aligned approximately parallel, or within 10° of parallel, to the longitudinal axis A1 of the furcation plug 70. As each subunit 44 reaches the middle region 96 of the furcation plug 70, it achieves its most aggressive pitch, which then fades to a less aggressive pitch as the subunit 44 approaches each end 80, 82 of the furcation plug 70. The base wall 88 of each groove 86 may extend circumferentially about 180° or more of the diameter of each subunit 44, thereby increasing the surface area contact between each subunit 44 and the furcation plug 70. This increased surface area contact enhances the friction between the furcation plug 70 and the subunit 44.

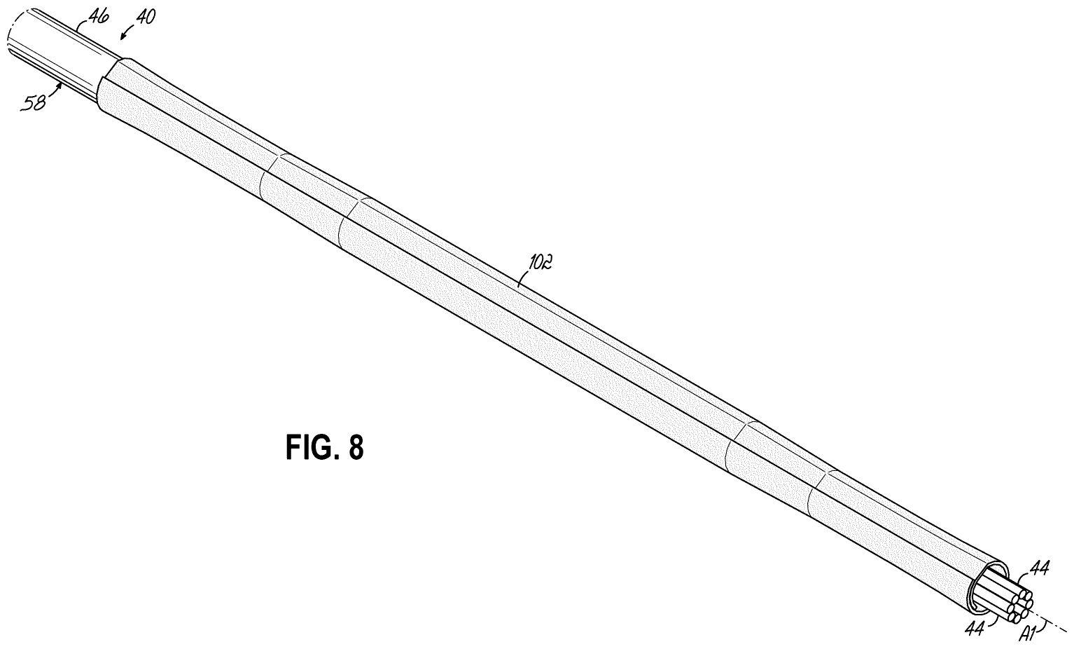

FIG. 8 is a perspective view of the fiber optic cable 40 after the subunits 44 have been helically wrapped about the furcation plug 70, as described above, and shows a sleeve 102 arranged over (e.g., applied to) the furcation plug 70 to cover the subunits 44 wrapped about the furcation plug 70 at the furcation point 72 to maintain the subunits 44 in their respective grooves 86 of the furcation plug 70. The sleeve 102 extends the entire length of the furcation plug 70 to cover the furcation point 72. The sleeve 102 may extend over the main cable section 58 to cover at least the jacket end 60 of the fiber optic cable 40, as shown. Examples of the sleeve 102 include expandable mesh, webbing, heat shrink tubing, and combinations thereof.

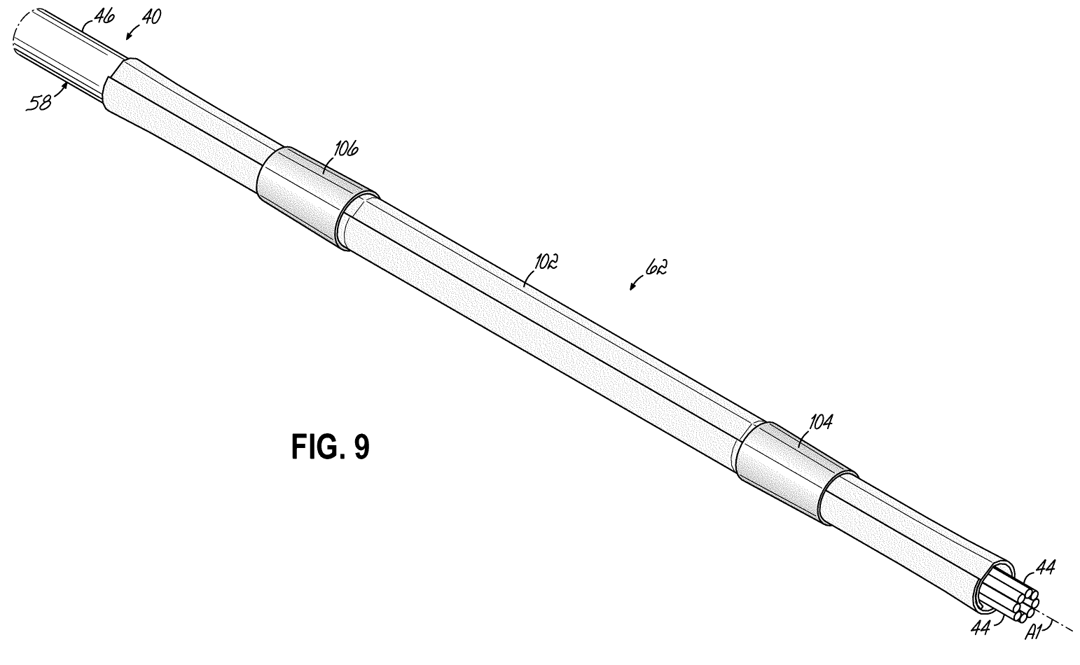

FIG. 9 is similar to FIG. 8 and illustrates a first maintaining member 104 and a second maintaining member 106 applied to the sleeve 102. The first maintaining member 104 is applied to the sleeve over the first end 80 of the furcation plug 70 and the second maintaining member 106 is applied to the sleeve 102 over the second end 82 of the furcation plug 70 to thereby hold the furcation plug 70 captive between the maintaining members 104, 106. In an alternative embodiment, the furcation assembly 62 may not include the sleeve 102 and the maintaining members 104, 106 may be mated or applied directly to the furcation plug 70. In either case, the maintaining members 104, 106 further operate to secure the subunits 44 in the grooves 86 at each end 80, 82 of the furcation plug 70. As shown, each maintaining member 104, 106 reduces the diameter of the sleeve 102 as it transitions over the furcation plug 70 to the bundle of exposed subunits 44 and/or the main cable section 58. The maintaining members 104, 106 create a slight bulge in the fiber optic cable 40 where the furcation plug 70 and furcation point 72 are located. Examples of the maintaining members 104, 106 include tape, strapping, shrink tubing, shrink-wrap, binder, yarn, epoxy, urethane sealant, adhesive material, and combinations thereof. The furcation plug 70, sleeve 102, and maintaining members 104, 106 may form the furcation assembly 62 according to one embodiment of the disclosure. However, as briefly described above, the furcation assembly 62 may include a furcation housing disposed over the furcation plug 70, sleeve 102, and maintaining members 104, 106. The furcation housing adds protection to the routable subunits 44 wrapped about the furcation plug 70 and may also serve to further secure the subunits 44 in their wrapped configuration.

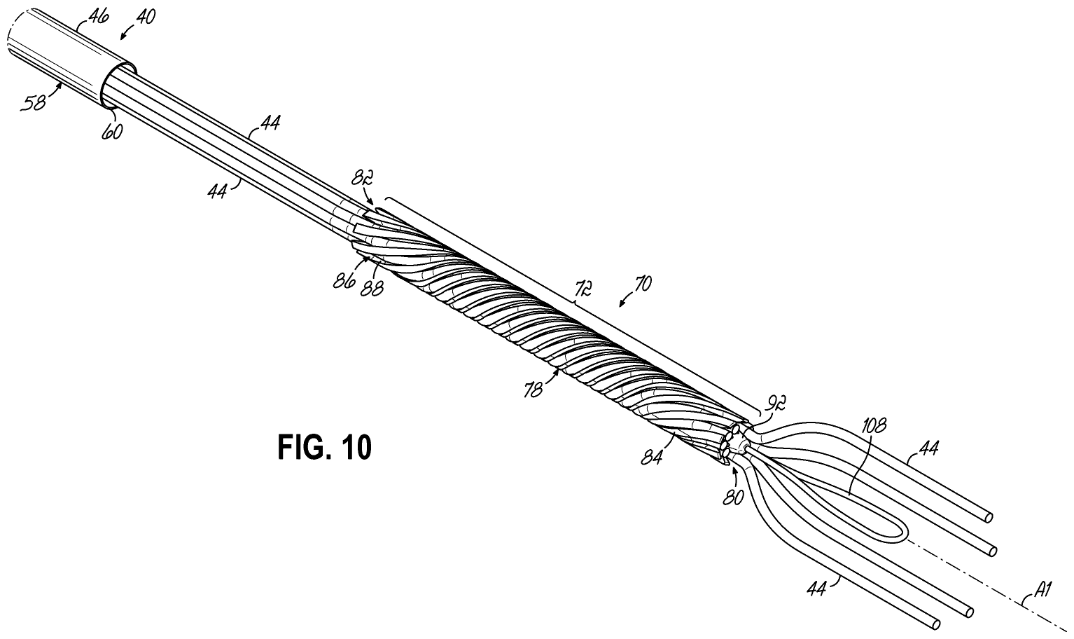

Referring now to FIG. 10, where like reference numerals represent like features compared to embodiments of the furcation assembly 62 described above with respect to FIGS. 1-9, the furcation plug 70 is shown according to an alternative embodiment of the present disclosure. As shown, the furcation plug 70 includes a pulling eye 108 attached to a projection 92 at one end 80, 82 of the furcation plug 70. The pulling eye 108 serves as an anchor point for a load-bearing pulling grip (not shown), allowing the fiber optic cable 40 to be safely pulled through a pathway. The pulling eye 108 may be secured within a blind hole molded into the furcation plug 70 or pass through the furcation plug 70 via an axial through-hole extending between ends 80, 82 of the furcation plug 70. The pulling eye 108 may be coupled to the furcation plug 70 using epoxy for a blind hole configuration or stoppers/knots for a through hole configuration, for example. Examples of the pulling eye 108 include paracord or an aramid loop, for example.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A fiber optic cable assembly, comprising:
a fiber optic cable including an outer jacket that surrounds a plurality of subunits each containing at least one optical fiber, the outer jacket having an end through which the plurality of subunits extends,
a furcation assembly proximate the end of the outer jacket through which the plurality of subunits extends, the furcation assembly comprising:
a furcation plug that extends longitudinally a length between a first end and an opposite second end,
wherein the furcation plug includes a plurality of grooves that extend helically about a periphery of the furcation plug between the first end and the second end, and
wherein each of the plurality of grooves receives a respective one of the plurality of subunits such that each of the plurality of subunits is wrapped around the furcation plug at least one time.

2. The fiber optic cable assembly of claim 1, wherein each of the plurality of subunits is wrapped around the furcation plug a same number of times.

3. The fiber optic cable assembly of claim 1, wherein each of the plurality of subunits is wrapped around the furcation plug at least three times.

4. The fiber optic cable assembly of claim 1, wherein the furcation plug includes a first end region adjacent the first end, a second end region adjacent the second end, and a middle region between the first end region and the second end region, and wherein for each of the plurality of grooves, a pitch of the groove in the middle region is different from a pitch of the groove in the first end region and the second end region.

5. The fiber optic cable assembly of claim 4, wherein for each of the plurality of grooves, the pitch of the groove at the first end region and the second end region is greater than the pitch of the groove in the middle region.

6. The fiber optic cable assembly of claim 5, wherein for each of the plurality of grooves, the pitch of the groove gradually decreases along a length of the first end region in a direction from the first end toward the middle region and gradually increases along a length of the second end region in a direction from the middle region toward the second end of the furcation plug.

7. The fiber optic cable assembly of claim 1, wherein each of the plurality of grooves is recessed from an outer surface of the furcation plug such that 50% or more of a diameter of each of the plurality of subunits is positioned within the respective groove and below the outer surface of the furcation plug.

8. The fiber optic cable assembly of claim 1, wherein:
each groove of the plurality of grooves includes an opening to the groove at the first end and the second end of the furcation plug;
the furcation plug includes a projection at each of the first end and the second end; and
the openings to the plurality of grooves are arranged circumferentially about each projection.

9. The fiber optic cable assembly of claim 8, wherein each projection is conical in shape, and wherein a tip of each projection is spaced axially away from the opening to each of the plurality of grooves.

10. The fiber optic cable assembly of claim 1, wherein each of the plurality of subunits enters or exits its respective groove at the first end and the second end of the furcation plug, and wherein an axis of each of the plurality of subunits is aligned within 10° of parallel to a longitudinal axis of the furcation plug at each of the first end and the second end of the furcation plug.

11. The fiber optic cable assembly of claim 1, wherein the furcation assembly includes a sleeve disposed over the furcation plug, and
wherein the furcation assembly further comprises:
a first maintaining member applied to the sleeve over the furcation plug at the first end, and
a second maintaining member applied to the sleeve over the furcation plug at the second end.

12. A method of making a fiber optic cable assembly, comprising:
providing a fiber optic cable including an outer jacket that surrounds a plurality of subunits each containing at least one optical fiber, the outer jacket having an end through which the plurality of subunits extends,
providing a furcation assembly proximate the end of the outer jacket through which the plurality of subunits extends, the furcation assembly including a furcation plug that extends longitudinally a length between a first end and an opposite second end, and
wrapping each of the subunits around the furcation plug such that each of the subunits is positioned in a respective one of a plurality of grooves that extend helically about a periphery of the furcation plug to define a furcation point of the fiber optic cable.

13. The method of claim 12, further comprising:
providing a first maintaining member and a second maintaining member as part of the furcation assembly,
mating the first maintaining member to the first end of the furcation plug, and
mating the second maintaining member to the second end of the furcation plug,
wherein the furcation plug is held captive between the first maintaining member and the second maintaining member.

14. A furcation plug for a furcation assembly of a fiber optic cable with a plurality of subunits, the furcation plug comprising:
a body that extends longitudinally a length between a first end and an opposite second end,
a plurality of grooves that extend helically about a periphery of the furcation plug between the first end and the second end, and
wherein each of the plurality of grooves is configured to receive a respective one of the plurality of subunits such that each of the plurality of subunits is wrapped around a the furcation plug at least one time.

15. The furcation plug of claim 14, wherein the body of the furcation plug includes a first end region adjacent the first end, a second end region adjacent the second end, and a middle region between the first end region and the second end region, and wherein for each of the plurality of grooves a pitch of the groove in the middle region is different from a pitch of the groove in the first end region and the second end region.

16. The furcation plug of claim 15, wherein for each of the plurality of grooves, the pitch of the groove at the first end region and the second end region is greater than the pitch of the groove in the middle region.

17. The furcation plug of claim 15, wherein for each of the plurality of grooves, the pitch of the groove gradually decreases along a length of the first end region in a direction from the first end toward the middle region and gradually increases along a length of the second end region in a direction from the middle region toward the second end of the furcation plug.

18. The furcation plug of claim 14, wherein each groove of the plurality of grooves includes an opening to the groove at the first end and the second end of the furcation plug, and wherein an axis of each of the plurality of grooves is aligned within 10° of parallel to a longitudinal axis of the furcation plug at each opening to the plurality of grooves at each of the first end and the second end of the furcation plug.

19. The furcation plug of claim 14, wherein each groove of the plurality of grooves includes an opening to the groove at the first end and the second end of the furcation plug, wherein the furcation plug further comprises a projection at each of the first end and the second end, and wherein the openings to the plurality of grooves are arranged circumferentially about each projection.

20. The furcation plug of claim 19, wherein each projection is conical in shape, and wherein a tip of each projection is spaced axially away from the opening to each of the plurality of grooves.
